(19) United States
(12) Patent Application Publication
(10) Pub. No.: US 2006/0158415 A1
(43) Pub. Date: Jul. 20, 2006

(54) Overdrive circuit having a temperature coefficient look-up table and liquid crystal display panel driving apparatus including the same

(75) Inventor: Takehito Izumi, Chiba (JP)

Correspondence Address: OLIFF & BERRIDGE, PLC, P.O. BOX 19928, ALEXANDRIA, VA, 22320, US

(73) Assignee: KAWASAKI MICROELECTRONICS, INC., Chiba (JP)

(21) Appl. No.: 11/320,577

(22) Filed: Dec. 30, 2005

(30) Foreign Application Priority Data
Jan. 14, 2005 (JP) 2005-007534

(51) Int. Cl. G09G 3/36

(52) U.S. Cl. 345/98

(57) ABSTRACT

A overdrive circuit and a liquid crystal display panel driving apparatus that can overdrive the display panel with a high accuracy without requiring a large memory capacity or a complicated arithmetic circuit is disclosed. The overdrive circuit includes a basic look-up table (LUT) that outputs a basic overdrive amount, and a temperature coefficient LUT that outputs a temperature coefficient of the overdrive amount. The overdrive circuit generates a corrected overdrive amount using the basic overdrive amount and the temperature coefficient.

### CROSS-REFERENCE TO RELATED APPLICATION

Exemplary embodiments of this invention were first described in Japanese Patent Application No. 2005-007534, which is hereby incorporated by reference in its entirety.

### BACKGROUND

Exemplary embodiments of this invention relate to an overdriving technique that enhances or improves the response and moving-image display quality of liquid crystal display panels.

Generally, a response of a liquid crystal to the change of the applied voltage is slow. Accordingly, when displaying a moving image on a liquid crystal display panel, unfavorable phenomena such as an after-image and a lasting image occur.

In order to reduce or suppress these phenomena, an overdriving technique is employed. That is, a voltage that is higher or lower than the voltage corresponding to the gray-scale level of the image to be displayed is applied to the display panel. As a result, the response of the liquid crystal is accelerated.

For example, if the pixel-driving signal to be applied to the liquid crystal display panel has 8-bits, or 256 steps, resolution, when the signal level changes from 0 to 128, a voltage corresponding to 144, which is the sum of the target level 128 and an overdrive amount of 16, is applied to the pixel of the liquid crystal display panel.

The amount of overdrive can be obtained by using a look-up table (LUT), which stores the overdrive amounts in relation to the combinations of the levels of the current-frame pixel data and the levels of the previous-frame data of the same pixel. That is, the overdrive amount may be obtained by referring to the LUT using the level of the previous-frame pixel data, which may be stored in a frame memory, and the level of the current-frame pixel data as parameters.

However, the response characteristic of a liquid crystal depends greatly on the temperature. Accordingly, the proper amount of overdrive changes with the change of the ambient temperature.

In order to address or overcome this problem, a technique is proposed in Patent Document 1 (JP 2004-133159). As shown in FIG. 6 of this application, a plurality of LUTs 200 is provided for storing appropriate overdrive amounts for various temperatures. A selection circuit 300 selects the proper one of the plurality of LUTs using the temperature information from the temperature sensor, and supplies the overdrive amount from the selected one of the LUTs to the LCD panel module 400.

Further, another technique is proposed in Patent Document 2 (JP 2004-109796). In FIG. 1 of Patent Document 2, a second arithmetic circuit 5 is provided. The second arithmetic circuit 5 performs temperature correcting processing to obtain an optimized, or an ideal, overdrive data.

However, a large amount of memory capacity is needed to provide the plurality of LUTs in order to adopt the above-mentioned technique disclosed in Patent Document 1. Moreover, the overdrive amount changes in stepwise manner when switching from one LUT to another. Accordingly, the image representation may become awkward along the change in the temperature.

In the technique disclosed in Patent Document 2, on the other hand, a plurality of LUTs is not required. Although Patent Document 2 does not disclose the detail of the second arithmetic circuit 5, however, a complicated circuit, which requires a large surface area on a semiconductor integrated circuit chip, may be required to obtain the ideal overdrive data.

### SUMMARY

An exemplary embodiment provides an overdrive circuit and a method of overdrive employing the overdrive technique to enable overdrive with high accuracy without requiring a large amount of memory capacity, or a complicated arithmetic circuit. Another exemplary embodiment provides a liquid crystal display panel driving apparatus employing the overdrive technique to enable driving a liquid crystal display panel with high accuracy without requiring a large amount of memory capacity, or a complicated arithmetic circuit.

In order to address or solve the above, various exemplary embodiments, according to this invention, provide an overdrive circuit that includes a basic LUT, a temperature coefficient LUT, and a temperature correction circuit. The basic LUT receives current-frame pixel data and previous-frame pixel data, and outputs a basic overdrive amount corresponding to a combination of levels of the current-frame pixel data and the previous-frame pixel data. The temperature coefficient LUT stores a plurality of temperature coefficients for correcting the basic overdrive amount. The temperature coefficient LUT receives temperature information, and outputs a corresponding temperature coefficient that corresponds to a temperature indicated by the temperature information. The temperature correction circuit outputs a corrected overdrive amount generated from the basic overdrive amount output from the basic LUT and the corresponding temperature coefficient output from the temperature coefficient LUT.

According to various exemplary embodiments, the temperature coefficient LUT may store the plurality of temperature coefficients at a plurality of representative temperatures. When the temperature indicated by the temperature information does not match any of the plurality of representative temperatures, the temperature coefficient LUT may generate the corresponding temperature coefficient by interpolating from two of the stored temperature coefficients at two of the representative temperatures on both sides of the indicated temperature.

According to various exemplary embodiments, the temperature coefficient LUT may store the plurality of temperature coefficients provided for a plurality of temperature segments, and the temperature coefficient LUT outputs one of the stored temperature coefficients provided for one of the segments that includes the temperature indicated by the temperature information as the corresponding temperature coefficient.

According to various exemplary embodiments, the temperature correction circuit may generate the corrected overdrive amount by multiplying the basic overdrive amount and the corresponding temperature coefficient.

In order to address or solve the above, various exemplary embodiments according to this invention provide a display panel driving apparatus that includes a liquid crystal display panel and a temperature sensor positioned within or near the display panel. The temperature sensor outputs temperature information that indicates a temperature of the display panel. The exemplary display panel driving apparatus further includes a processing circuit that generates and outputs an output signal to the display panel. The processing circuit includes a basic LUT, a temperature coefficient LUT and a temperature correction circuit. The basic LUT outputs a basic overdrive amount, the temperature coefficient LUT outputs a corresponding temperature coefficient corresponding to the temperature indicated by the temperature information, and the temperature correction circuit outputs a corrected overdrive amount generated from the basic overdrive amount output from the basic LUT and the corresponding temperature coefficient output from the temperature coefficient LUT so that the processing circuit generates the output signal using the corrected overdrive amount.

According to various exemplary embodiments, the processing circuit may further include an adder that generates the output signal by adding the level of the current-frame pixel data and the corrected overdrive amount.

According to various exemplary embodiments, the processing circuit may further include a limiter that limits a level of the output signal within a range that the display panel can display.

In order to address or solve above, various exemplary embodiments according to this invention provide a method of overdrive that includes inputting current-frame pixel data and previous-frame pixel data to a basic LUT and outputting a basic overdrive amount corresponding to a combination of levels of the current-frame pixel data and the previous-frame pixel data from the basic LUT, inputting temperature information to a temperature coefficient LUT and outputting a temperature coefficient that corresponds to a temperature indicated by the temperature information from the temperature coefficient LUT, and generating a corrected overdrive amount from the basic overdrive amount output from the basic LUT and the temperature coefficient output from the temperature coefficient LUT.

### BRIEF DESCRIPTION OF THE DRAWINGS

FIG. 1 is a schematic that shows an overdrive circuit and a liquid crystal display panel driving apparatus according to an exemplary embodiment of this invention;

FIG. 2A is a LUT for a temperature coefficient LUT according to the first exemplary embodiment of this invention;

FIG. 2B is a LUT for an exemplary temperature coefficient LUT according to the first exemplary embodiment of this invention;

FIG. 3 is a graph that shows a relationship between the representative temperatures and temperature coefficients stored in the temperature coefficient LUT according to the first exemplary embodiment of this invention;

FIG. 4 is a schematic that shows an interpolation according to the first exemplary embodiment of this invention;

FIG. 5 is an LUT for an exemplary temperature coefficient LUT according to the second exemplary embodiment of this invention; and

FIG. 6 is a schematic that shows a related art liquid crystal display driving apparatus.

### DETAILED DESCRIPTION OF EMBODIMENTS

Exemplary overdrive circuits, exemplary methods of overdrive, and exemplary liquid crystal display panel driving apparatus according to this invention will be explained in detail with reference to the exemplary embodiments shown in attached drawings.

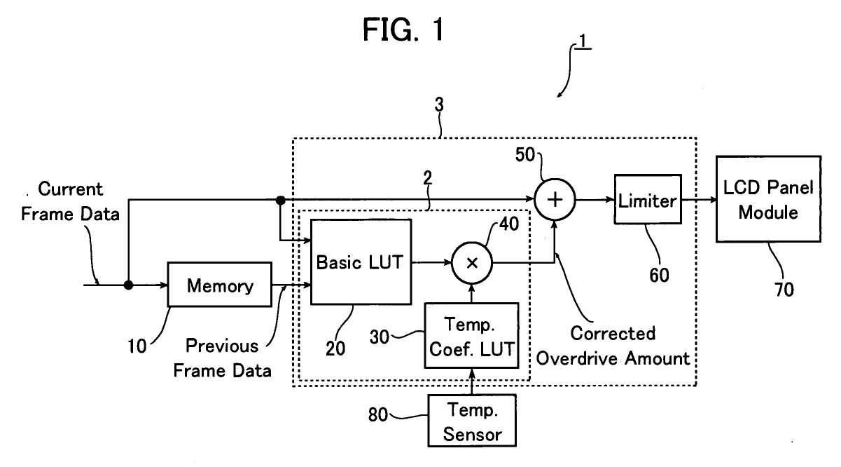

FIG. 1 is a schematic that shows an exemplary embodiment of an overdrive circuit and a liquid crystal display panel driving apparatus according to this invention.

The exemplary liquid crystal display panel driving apparatus shown in FIG. 1 includes: a frame memory 10, an overdrive circuit 2, an adder 50, a limiter 60, and a LCD panel module 70. The exemplary apparatus also includes a temperature sensor 80 placed within or near the LCD panel module 70.

Frame memory 10 is a memory that stores the data of one frame. The pixel data stored in the frame memory 10 is read after one frame period and is inputted to the basic LUT 20 as the previous-frame data.

Here, the frame memory 10 may store the frame data as it is, but it may also store an altered data that corresponds to the frame data. For example, the frame memory 10 may store the data of the frame after the data is compressed, thereby to reduce the necessary memory capacity of the frame memory. In this case, the data is expanded when it is read from the frame memory 10.

The overdrive circuit 2 includes a basic LUT 20 and a temperature coefficient LUT 30. The basic LUT 20 stores basic overdrive amounts, and the temperature coefficient LUT 30 stores temperature coefficients of the overdrive amount. The overdrive circuit 2 further includes a multiplier 40, which operates as the temperature correction circuit according to the exemplary embodiment shown in FIG. 1.

Hereafter, the operations of the components of the overdrive circuit 2 will be described.

Pixel data for each frame is inputted successively to the liquid crystal display panel driving apparatus 1 with a prescribed frame rate. Image data for each pixel has 24-bits, i.e., it comprises R, G, and B data, each having 8-bits. The pixel data for the current-frame is inputted as serial data generated by scanning the frame in the horizontal and vertical directions.

The basic LUT 20 of the exemplary overdrive circuit 2 receives the pair of parameters including the data (the gray-scale level) of a certain pixel in the current-frame and the data (the gray-scale level) of the same pixel in the previous-frame. Then, the basic LUT 20 outputs the basic overdrive amount stored in the LUT 20 in relation to the pair of parameters.

The basic LUT 20 may utilize the combination of the gray-scale levels of the input pixel data in the current-frame and the previous-frame as the address. That is, the basic LUT 20 may store the overdrive amounts corresponding to the combinations of the gray-scale levels of the pixel data in the current-frame and the previous-frame at the addresses designated by the combinations of the levels of the pixel data.

Accordingly, a relatively large memory capacity, which is equal to the number of bits of each overdrive amount times the number of addresses corresponding to the combinations of the two pixel data, is required for the basic LUT 20. In order to provide a plurality of LUTs for a plurality of temperatures as proposed in Patent Document 1, a plurality of large-capacity memories is required.

According to various exemplary embodiments of this invention, on the other hand, only one LUT (the basic LUT) is needed. The basic LUT may store the amounts of overdrive at a reference temperature of, for example, 25° C.

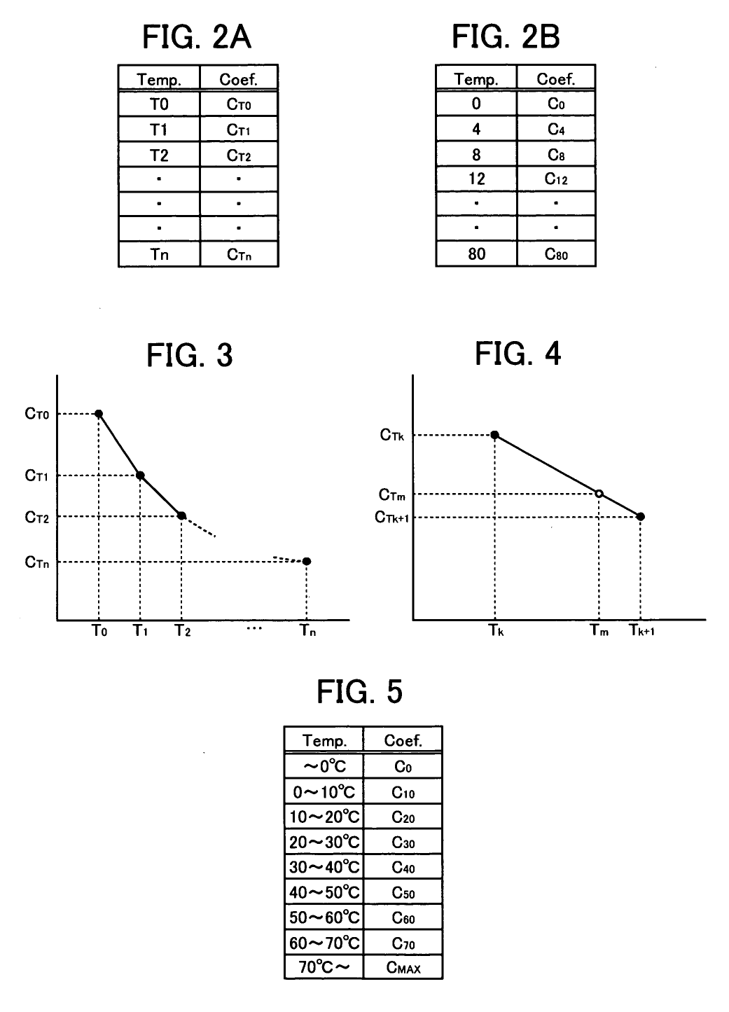

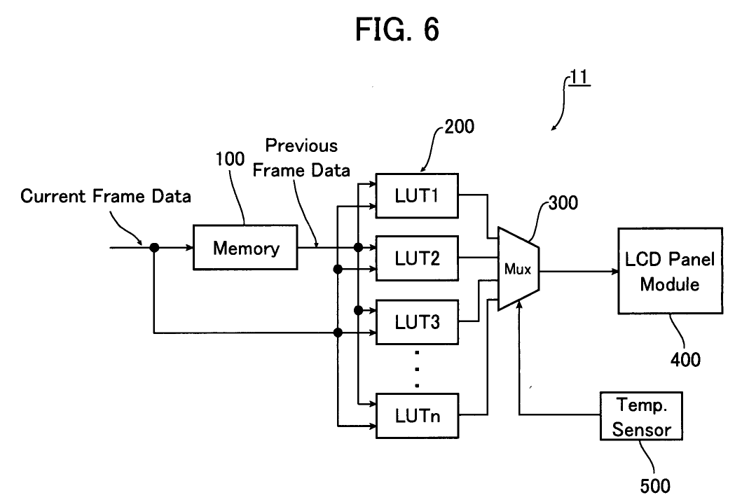

The exemplary overdrive circuit according to the first exemplary embodiment includes the temperature coefficient LUT 30. The temperature coefficient LUT 30 stores temperature coefficients C_{Tn} of the overdrive amount at a plurality of temperatures Tn (the representative temperatures), as shown in FIG. 2A.

FIG. 3 is a graph that shows the operation of temperature coefficient LUT 30 shown in FIG. 2A. For example, the temperature coefficient LUT 30 stores temperature coefficients C₀, C₄, C₈ . . . C₈₀ at every 4° C. from 0° C. to 80° C., as shown in FIG. 2B.

When the temperature information output from the temperature sensor 80 indicates one of the representative temperatures stored in the temperature coefficient LUT 30, the LUT 30 outputs the coefficient corresponding to the representative temperature to the multiplier 40. For example, when the temperature information output from the temperature sensor 80 indicates the temperature T5, the LUT 30 outputs the coefficient C_{T5} corresponding to the temperature T5 to the multiplier 40. In the exemplary overdrive circuit shown in FIG. 1, the multiplier 40 operates as an exemplary temperature correction circuit.

When the temperature indicated by the temperature information output from the temperature sensor 80 does not match any one of the representative temperatures stored in the temperature coefficient LUT 30, a temperature coefficient at that temperature is calculated from two of the temperature coefficients stored in the coefficient LUT 30. For example, as shown in FIG. 4, when the temperature Tm indicated by the temperature information output is between the temperatures Tk and Tk+1, the coefficient is calculated by the linear interpolation from the coefficients C_{Tk} and C_{Tk+1} at the temperatures Tk and Tk+1.

For example, if the temperature Tm indicated by the temperature information output from the temperature sensor 80 is between Tk and Tk+1, where Tk+1 is higher than Tk, then the temperature coefficient C_{Tm} at the temperature Tm can be calculated by the following equation:
C_{Tm}=C_{Tk}+(Tm−Tk)×(C_{Tk+1}−C_{Tk})/(Tk+1−Tk)

For example, when the temperature indicated by the temperature information output from the temperature sensor 80 is 11° C., the temperature coefficient C₁₁ can be calculated using the coefficients stored in the exemplary temperature coefficient LUT shown in FIG. 2B by the following equation:
C₁₁=C₈+(11−8)×(C₁₂−C₈)/4

According to the first exemplary embodiment shown in FIG. 1, the temperature coefficient LUT 30 includes the interpolation circuit.

The temperature sensor 80 may preferably be placed adjacent to the LCD panel so that the temperature of the LCD panel can be measured accurately. Further preferably, the temperature sensor 80 may be placed within the LCD panel module 70.

In the exemplary embodiment shown in FIG. 1, the temperature correction circuit includes the multiplier 40. The multiplier receives the basic overdrive amount output from the basic LUT 20 and the temperature coefficient output from the temperature coefficient LUT 30. The multiplier multiplies the basic overdrive amount and the temperature coefficient, generates an overdrive amount suitable to the temperature indicated by the temperature information, and outputs the generated (corrected) overdrive amount to the adder 50.

If the temperature coefficient C_{T5} at the temperature T5 is 1.0, for example, the overdrive amount after the correction is identical to the basic overdrive amount. On the other hand, if the temperature coefficient C_{T0} at T0 is 2.0, the overdrive amount after the correction is two-times the basic overdrive amount.

The temperature correction circuit according to various exemplary embodiments of this invention is not limited to the above-mentioned multiplier. The temperature correction circuit may conduct various calculations from the basic overdrive amount and the temperature coefficient. For example, the temperature correction circuit may further add a fixed value to the result of the multiplication of the temperature coefficient and the basic overdrive amount.

According to various exemplary embodiments of this invention, the overdrive circuit is basically as explained above. The overdrive circuit includes, at minimum, the basic LUT 20, the temperature coefficient LUT 30 and the temperature correction circuit 40.

Next, the adder 50 receives the current-frame pixel data and the corrected overdrive amount output from the multiplier 40. The adder 50 adds the corrected overdrive amount to the level of current-frame pixel data and outputs an output data including the corrected (overdriven) pixel data.

The operation of the overdrive circuit and that of the liquid crystal display panel driving apparatus according to various exemplary embodiments of this invention will be explained. For example, the explanation will be made assuming that only one of the RGB color elements is processed.

For example, if the Red element of a certain pixel in the previous-frame and that of the same pixel in the current-frame have the gray-scale levels of 0 and 128, respectively, then the basic LUT 20 outputs the basic overdrive amount corresponding to the combination of the gray-scale levels at a reference temperature of, for example, 20° C.

The

For example, if the basic overdrive amount output from the basic LUT 20 is 16 and the temperature indicated by the temperature information output from the temperature sensor 80 is 20° C., then the temperature coefficient LUT 30 outputs a coefficient of 1.0 because the temperature indicated by the temperature information is equal to the reference temperature. The multiplier 40 outputs the same output from the basic LUT 20.

Finally, the adder 50 outputs the corrected gray-scale level of 144, which is the sum of the current-frame level of 128 and the corrected overdrive amount of 16.

On the other hand, if the temperature indicated by the temperature information output from the temperature sensor 80 is 0° C. and the temperature coefficient corresponding to the temperature of 0° C. is 2.0, then the multiplier 40 outputs the corrected overdrive amount of 16×2.0=32. The adder 50 adds this corrected overdrive amount to the current-frame gray-scale level of 128 and outputs the corrected gray-scale level of 160.

However, the level of the output of the adder may exceed the range of the gray-scale level that the liquid crystal display panel can display. Accordingly, the limiter 60 that limits the level of the signal to supply to the liquid crystal display panel module 70 is provided in the exemplary liquid crystal display panel driving apparatus 1, as shown in FIG. 1.

For example, if the liquid crystal display panel can display 8-bits levels from 0 to 255, the limiter 60 corrects the level of the output signal from the adder 50 to 255 when the level of the output signal from the adder 50 is 256 or more. On the other hand, the limiter 60 corrects the level of the output signal from the adder 50 to 0, when the level of the output signal from the adder is less than 0.

However, the limiter 60 is not an indispensable element in the exemplary liquid crystal display panel driving apparatus according to this invention. In other words, the exemplary liquid crystal display panel driving apparatus does not have to include the limiter 60. For example, it is also possible to modify the adder 50 to have the limiting function.

Finally, the limiter 60 supplies the output signal including the overdriven digital data of each pixel to the LCD panel module 70. That is, in the exemplary liquid crystal display panel driving apparatus 1 shown in FIG. 1, the overdrive circuit 2, the adder 50, and the limiter 60 constitute a processing circuit 3 that generates the output signal to be supplied to the liquid crystal display module 70.

The LCD panel module includes a D/A converter and a liquid crystal display driver. The D/A converter converts the input digital data into analog voltages, and the liquid crystal display driver applies the analog voltages to respective pixels of the LCD panel.

As explained above, according to various exemplary overdrive circuits, methods of overdrive, and liquid crystal display panel driving apparatus of this invention, it is not required to provide a plurality of LUTs for respective temperatures. Moreover, the temperature coefficient LUT only requires a small amount of memory capacity. Accordingly, the amount of required memory capacity can be greatly reduced.

Furthermore, a complicated arithmetic circuit is not needed as the temperature correction circuit. For example, a simple circuit such as the multiplier 40 can be used as the temperature correction circuit.

Thus, when fabricating a semiconductor integrated circuit including the overdrive circuit or the processing circuit according to exemplary embodiments of this invention, the required area of the semiconductor substrate may be minimized.

Moreover, because the temperature coefficient is obtained by an interpolation such as the linear interpolation, a highly accurate correction according to the temperature is realized. Accordingly, high quality moving images can be displayed.

Next, another exemplary temperature coefficient LUT 30 according to the second exemplary embodiment of this invention will be described.

According to the first exemplary embodiment, the temperature coefficient LUT 30 stores temperature coefficients at a plurality of representative temperatures and the temperature coefficient corresponding to the temperature of the liquid crystal display panel is calculated by the linear interpolation. According to the second exemplary embodiment, on the other hand, a supposed range of the temperature of the liquid crystal display panel is divided into several segments and fixed temperature coefficients are provided for the respective temperature segments.

FIG. 5 is an LUT for exemplary temperature coefficient LUT used for the second exemplary embodiment.

As shown in FIG. 5, the exemplary temperature coefficient LUT outputs a coefficient C₀ when the temperature indicated by the temperature sensor is 0° C. or below. The exemplary LUT further outputs a coefficient C₁₀ when the temperature indicated by the temperature sensor 80 is between 0° C. to 10° C., and . . . C_{MAX} when the temperature is higher than 70° C.

According to the second exemplary embodiment, it is not necessary to divide the range of the temperature into segments with a fixed width. For example, an area of the temperature that the coefficient changes rapidly may be divided into segments with smaller widths. On the other hand, an area of the temperature that the coefficient does not change rapidly may be divided into segments with larger widths.

Exemplary overdrive circuits, methods of overdrive, and exemplary liquid crystal display panel driving apparatus are explained in detail above in reference to exemplary embodiments. However, this invention is not limited to the specific embodiments described above. It is possible to make various improvements and modifications in the spirit of this invention.

In the basic LUT 20, according to various exemplary overdrive circuits and exemplary liquid crystal display driving apparatus of this invention, it is not necessary to store each of the overdrive amounts corresponding to all the combinations of the previous-frame and the current-frame gray-scale levels. It is known in the art that the basic LUT 20 may selectively store overdrive amounts for some of the combinations of the gray-scale levels. For example, combinations of upper 4-bits of the gray-scale levels may be selectively stored. In this case, the overdrive amounts corresponding to the combinations not stored in the LUT 20 may be generated by interpolations.

The generation of the overdrive amounts by interpolation is disclosed in, for example, the co-pending application Ser. No. 11/207,870 (OLIFF & BERRIDGE Ref 124924), which is hereby incorporated by reference in its entirety.

What is claimed is:

1. An overdrive circuit, comprising:
a basic look-up table (LUT) that receives current-frame pixel data and previous-frame pixel data, and outputs a basic overdrive amount corresponding to a combination of levels of the current-frame pixel data and the previous-frame pixel data;
a temperature coefficient LUT that stores a plurality of temperature coefficients for correcting the basic overdrive amount, the temperature coefficient LUT receiving temperature information and outputting a corresponding temperature coefficient that corresponds to a temperature indicated by the temperature information; and
a temperature correction circuit that outputs a corrected overdrive amount generated from the basic overdrive amount output from the basic LUT and the corresponding temperature coefficient output from the temperature coefficient LUT.

2. The overdrive circuit according to claim 1, wherein:
the temperature coefficient LUT stores the temperature coefficients at a plurality of representative temperatures; and
when the temperature indicated by the temperature information does not match any of the plurality of representative temperatures, the temperature coefficient LUT generates the corresponding temperature coefficient by interpolating from two of the plurality of stored temperature coefficients at two of the plurality of representative temperatures on both sides of the indicated temperature.

3. The overdrive circuit according to claim 1, wherein:
the temperature coefficient LUT stores the plurality of temperature coefficients provided for a plurality of temperature segments; and
the temperature coefficient LUT outputs one of the stored plurality of temperature coefficients provided for one of the segments that includes the temperature indicated by the temperature information as the corresponding temperature coefficient.

4. The overdrive circuit according to claim 1, wherein the temperature correction circuit generates the corrected overdrive amount by multiplying the basic overdrive amount and the corresponding temperature coefficient.

5. A display panel driving apparatus, comprising:
a liquid crystal display panel;
a temperature sensor positioned within or near the display panel, the temperature sensor outputting temperature information that indicates a temperature of the display panel;
a processing circuit that generates and outputs an output signal to the display panel, the processing circuit including:
a basic look-up table (LUT) that receives current-frame pixel data and previous-frame pixel data, and outputs a basic overdrive amount corresponding to a combination of levels of the current-frame pixel data and the previous-frame pixel data;
a temperature coefficient LUT that stores a plurality of temperature coefficients for correcting the basic overdrive amount, the temperature coefficient LUT receiving the temperature information and outputting a corresponding temperature coefficient corresponding to the temperature indicated by the temperature information; and
a temperature correction circuit that outputs a corrected overdrive amount generated from the basic overdrive amount output from the basic LUT and the corresponding temperature coefficient output from the temperature coefficient LUT so that the processing circuit generates the output signal using the corrected overdrive amount.

6. The apparatus according to claim 5, wherein the temperature correction circuit includes a multiplier that generates the corrected overdrive amount by multiplying the basic overdrive amount and the corresponding temperature coefficient.

7. The apparatus according to claim 5, wherein the processing circuit further comprises:
an adder that generates the output signal by adding the level of the current-frame pixel data and the corrected overdrive amount.

8. The apparatus according to claim 5, wherein the processing circuit further comprises:
a limiter that limits a level of the output signal within a range that the display panel can display.

9. A method of overdrive, comprising:
inputting current-frame pixel data and previous-frame pixel data to a basic look-up table (LUT), and outputting a basic overdrive amount corresponding to a combination of levels of the current-frame pixel data and the previous-frame pixel data from the basic LUT;
inputting temperature information to a temperature coefficient LUT and outputting a temperature coefficient that corresponds to a temperature indicated by the temperature information from the temperature coefficient LUT; and
generating a corrected overdrive amount from the basic overdrive amount output from the basic LUT and the temperature coefficient output from the temperature coefficient LUT.

10. The method according to claim 9, wherein:
the temperature coefficient LUT stores a plurality of representative temperature coefficients at a plurality of representative temperatures; and
when the temperature indicated by the temperature information does not match any of the plurality of representative temperatures, the temperature coefficient that corresponds to the indicated temperature is generated by interpolating from two of the plurality of representative temperature coefficients at two of the representative temperatures on both sides of the indicated temperature.

11. The method according to claim 9, wherein:
the temperature coefficient LUT stores a plurality of representative temperature coefficients provided for a plurality of temperature segments; and
the temperature coefficient that corresponds to the temperature indicated by the temperature information is output by outputting one of the plurality of representative temperature coefficients provided for one of the segments that includes the indicated temperature.

12. The method according to claim 9, wherein the corrected overdrive amount is generating by multiplying the basic overdrive amount and the corresponding temperature coefficient.
